(19) United States
(12) Patent Application Publication
(10) Pub. No.: US 2006/0203999 A1
(43) Pub. Date: Sep. 14, 2006

(54) Communication glove

(76) Inventor: Gary Mirzakhanov, Colorado Springs, CO (US)

Correspondence Address: Gary Mirzakhanov, 2538 Integrity Court, Colorado Springs, CO, 80918, US

(21) Appl. No.: 11/076,826

(22) Filed: Mar. 10, 2005

(51) Int. Cl. H04M 1/00; H04M 9/00

(52) U.S. Cl. 379/433.01

(57) ABSTRACT

A communication glove comprises a glove member (5) with the attached battery (24), earpiece transducer (8), microphone transducer (9) and communication device (4) that comprises a flexible keypad (23) & display (25). The earpiece transducer (8) is electrically coupled to the communication device (4) and is carried by the glove member (5) at a top of middle finger (22) of the person's hand (6). Person's ear (10) listens to acoustic signals (11) generated by the earpiece transducer (8) when a top of middle finger (22) of person's hand (6) is held against an ear (10) of the person.

The microphone transducer (9) is electrically coupled to the communication device (4) and is carried by the glove member (5) at a location on the inside (14) of the wrist (18) of the person when the glove member (5) is worn on the hand (6) of the person to permit a mouth (12) of the person to speak acoustic signals (13) into the microphone transducer (9) when the hand (6) of the person is held against the head (7) of the person.

### CROSS-REFERENCES TO RELATED APPLICATIONS

U.S. Pat. No. 6,044,153, by Kaschke, on Mar. 28, 2000.

### STATEMENT OF FEDERALLY SPONSORED RESEARCH/DEVELOPMENT

Not Applicable

### INCORPORATION-BY-REFERENCE OF MATERIAL SUBMITTED ON COMPACT DISC

Not Applicable

### BACKGROUND OF THE INVENTION

This invention relates to the communication devices and particularly to a glove cellular telephone, adapted to be worn on a person's hand.

All telephones have the acoustic interfaces that allow one person to communicate with another person at the remote location. An acoustic interface generally includes an earpiece transducer and a microphone transducer. Typically, the earpiece transducer and the microphone transducer are located in the device that is called a telephone handset. To communicate the user holds the telephone handset against the user's head so as to align the earpiece transducer with the user's ear and to align the microphone transducer with the user's mouth. Therefore, the user can communicate using the telephone handset by speaking into the microphone transducer while listening to the earpiece transducer.

Using a telephone handset can cause a physical discomfort. Person can drop the telephone handset while in use or misplace the telephone handset after using it

To solve these problems, some telephones are adapted to use a telephone headset or an earpiece transducer and a microphone transducer integrated into garments. This solution is inappropriate when the user does not want to wear the telephone headset or garments, plus telephone handset itself should be placed somewhere or hold by a person.

Some other telephones (see U.S. Pat. No. 6,044,153) were designed as hand adaptive communication devices, and have a display mounted together with a keypad making them too big and rigid to be worn on a person's hand. Their earpiece transducer on the palm is too close to a microphone transducer that is placed on the wrist and makes these devices not comfortable or convenient to wear witch means not practical for the real life.

This conclusion is based on the absence of these kinds of devices on the market.

In this modern life it is convenient to have a hand adaptive communication device that consists of a flexible keypad & a display that is attached to the glove member that can be worn on a person's hand and be an integral part of person's dress. It is very practical to have a flexible keypad comfortably located on the person's hand to easily enter information. It is convenient to have display on the place where traditionally watch is worn to receive visual information including the time, and an earpiece transducer located at the most convenient place on a hand—at the top of the middle finger to receive information, and a microphone at the wrist to provide information.

### BRIEF SUMMARY OF THE INVENTION

A communication glove comprises a glove member with the attached communication device, battery, earpiece transducer and microphone transducer.

The glove member is adapted to be worn on a hand of a person.

The communication device comprises the flexible keypad and display.

The earpiece transducer is electrically coupled to the communication device and is carried by the glove member at a top of middle finger of the person's hand. Person's ear listens to acoustic signals generated by the earpiece transducer when a top of middle finger of person's hand is held against an ear of the person.

The microphone transducer is electrically coupled to the communication device and is carried by the glove member at a location on the inside of the wrist of the person when the glove member is worn on the hand of the person to permit a mouth of the person to speak acoustic signals into the microphone transducer when the hand of the person is held against the head of the person.

### BRIEF DESCRIPTION OF THE SEVERAL VIEWS OF THE DRAWINGS

FIG. 1 illustrates, in a top and right side perspective view of the communication glove including a glove member adapted to be worn on a person's hand and other devices attached to it.

FIG. 2 illustrates, in a rear side view of the communication glove including the glove member of FIG. 1 adapted to be worn on the person's hand.

FIG. 3 illustrates, in a left side elevation view of the communication glove including the glove member of FIGS. 1 and 2 adapted to be worn on the person's hand wherein the person's hand is held next to the person's head.

### DETAILED DESCRIPTION OF THE INVENTION

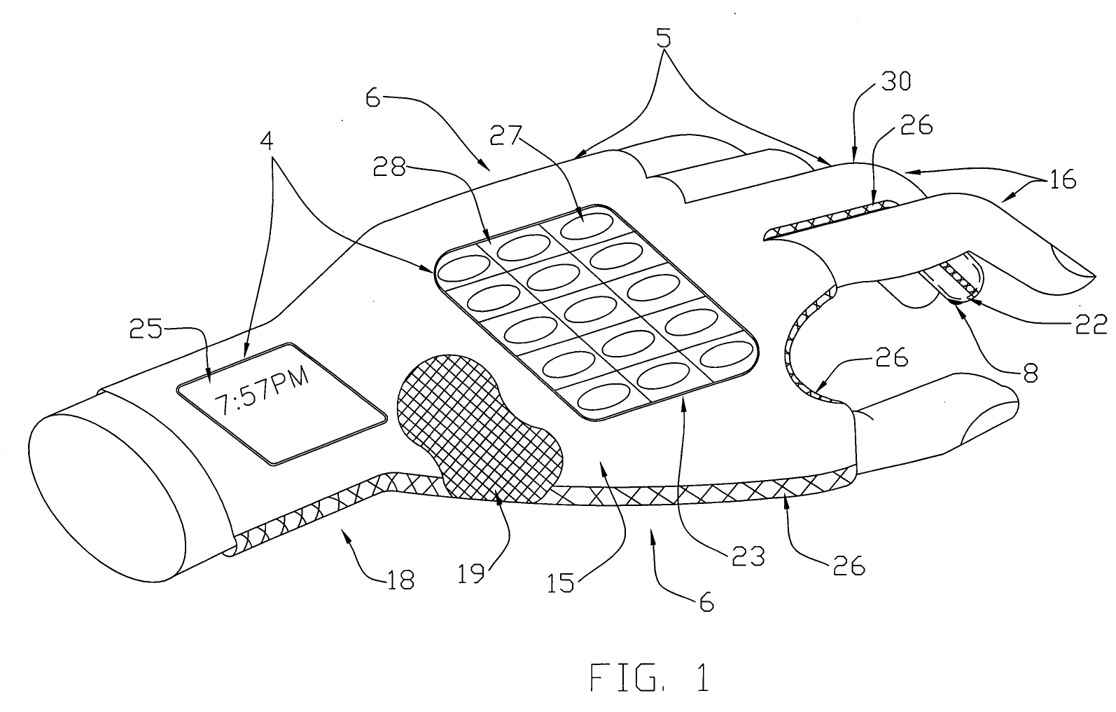

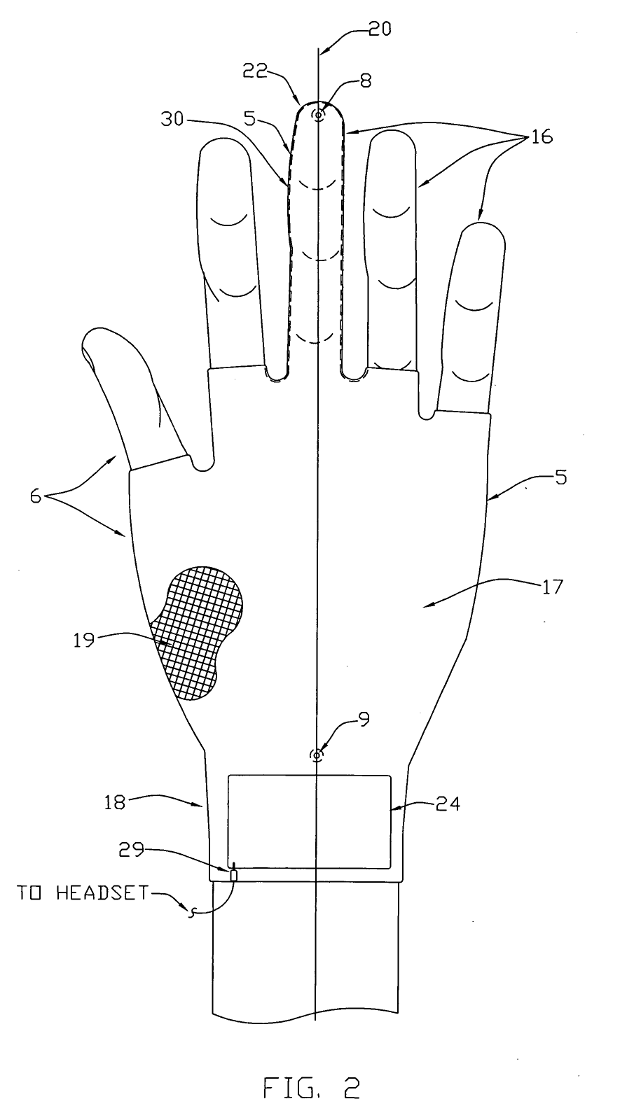

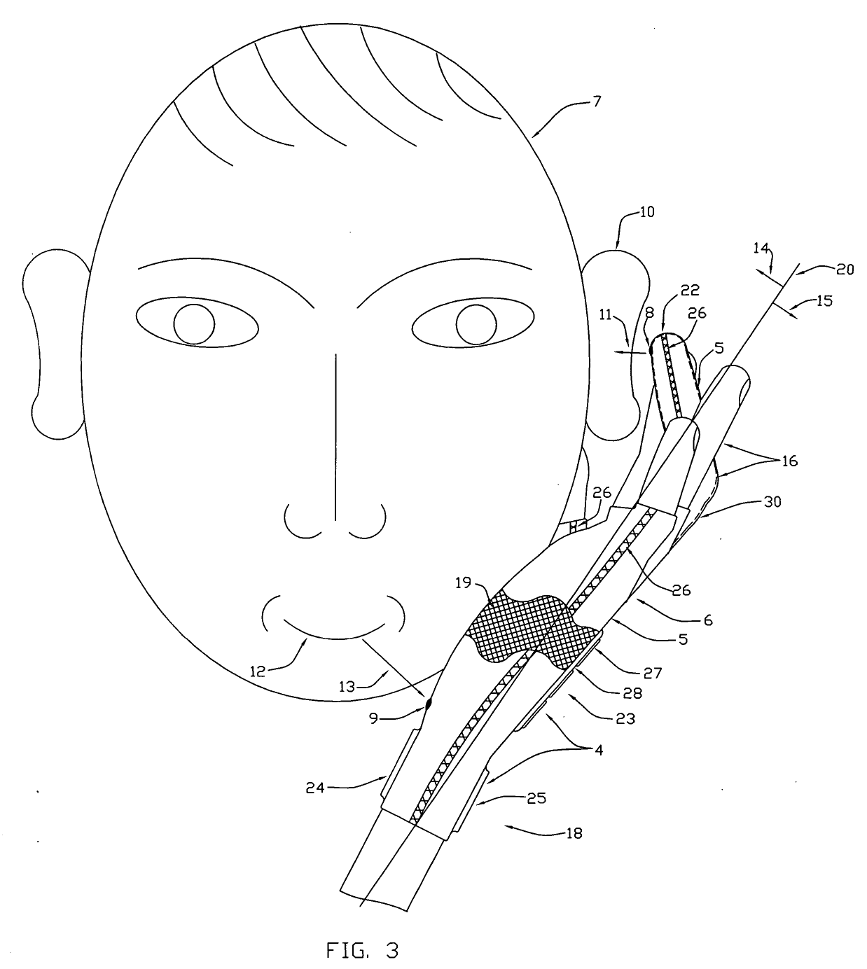

FIGS. 1, 2 and 3 together illustrate the communication device 4, battery 24 and transducers 8 & 9 attached to the glove member 5 adapted to be worn on a person's hand 6. FIG. 1 illustrates the communication device 4 attached to the outside 15 of glove member 5 and adapted to be worn on a person's hand 6. FIG. 2 illustrates the battery 24 and transducers 8 & 9 attached to the inside 14 of glove member 5 and adapted to be worn on a person's hand 6. FIG. 3 illustrates a left side elevation view of the glove member 5 with the attached communication device 4, battery 24 and transducers 8 & 9 as shown on FIGS. 1 and 2 and adapted to be worn on the person's hand 6 wherein the person's hand 6 is held next to the person's head 7.

The communication glove comprises a glove member 5 adapted to be worn on a hand 6 of a person and the communication device 4 carried by the glove member 5. The user interface mechanism includes an earpiece transducer 8 and a microphone transducer 9.

Generally, the inside 14 of the person's hand 6 refers to the palm side of the person's hand 6 and includes the inside 14 of the person's fingers 16, the inside 14 of the person's palm 17 and the inside 14 of the person's wrist 18 of the person's hand 6. Further, the outside 15 of the person's hand 6 refers to the back side of the person's hand 6 having the person's knuckles and includes the outside 15 of the person's fingers 16, the outside 15 of the person's palm 17 and the outside 15 of the person's wrist 18 of the person's hand 6.

The earpiece transducer 8 is adapted to be coupled to a communication device 4 and carried by the glove member 5 at the most convenient place on a hand—at the top of the middle finger 22 of finger compartment 30 at a location on the inside 14 of the hand 6 when the glove member 5 is worn on the hand 6 of the person. It permits an ear 10 of the person to listen to acoustic signals 11 generated by the earpiece transducer 8 when the hand 6 is held against a head 7 of the person and a top of middle finger of person's hand 6 is held against an ear 10 of the person.

The earpiece transducer 8 can be located at the top of any fingers 16 if it will be considered as a convenient location.

The microphone transducer 9 is adapted to be coupled to a communication device 4 and carried by the glove member 5 at a location on the inside 14 at the wrist 18 of the hand 6 of the person when the glove member 5 is worn on the hand 6 of the person. It permits a mouth 12 of the person to speak acoustic signals 13 into the microphone transducer 9 when the hand 6 of the person is held against the head 7 of the person.

The earpiece transducer 8 and the microphone transducer 9 together provide an acoustic interface for the person using the communication device 4.

Preferably, the communication glove provides wireless communications, such as, for example, over radio waves. Preferably, the communication device 4 operates in a cellular band of radio frequencies that is widely used. However, any radio frequency band may be used.

The communication glove provides the person with the following advantages while the glove member 5 is worn on the person's hand 6. The person cannot drop or misplace the telephone handset while not in a call. The person can check or answer or make telephone calls more quickly because the display and the flexible keypad located at the convenient places of the person's hand and he/she does not need to expend the time to retrieve a telephone handset. The communication glove is physically more comfortable than holding a separate handset because the person's own hand 6 provides the contoured shape of the acoustic interface. Further, the communication glove provides the user with a close coupled acoustic interface when wearing a headset having an earpiece transducer and a microphone transducer connected to communication device with the connector 29. The communication glove may be advantageously used by active people who need readily available portable communications apparatus that can be used in the work environment or in the recreational environment including walking, jogging and so on.

The microphone transducer 9 and the earpiece transducer 8 are spaced apart along a common axis. The common axis is preferably a longitudinal axis 20 of the person's hand 6 which runs parallel with the person's fingers 16. By locating the microphone transducer 9 and the earpiece transducer 8 on the longitudinal axis 20, the microphone transducer 9 and the earpiece transducer 8 are in the best location for aligning with the person's mouth 12 when the person's hand 6 is held against the person's head 7.

Once the glove member 5 is worn on the person's hand 6 the microphone transducer 9 are disposed in fixed locations on the inside 14 of the person's hand 6. The earpiece transducer 8 should be located at the most convenient place on a hand—at the top of middle finger 22 or close to the top of middle finger 22 on the inside 14 of the person's hand 6. The microphone transducer 9 should be located on the inside 14 of the person's wrist 18 as shown in FIGS. 2 and 3. These locations advantageously permit the person to open and close their hand 6 and to use their fingers 16 with minimal physical interference from the earpiece transducer 8 and the microphone transducer 9 while providing for comfortable alignment with the user's ear 10 and mouth 12, respectively, when the person's hand 6 is placed next to the person's head 7.

The glove member 5 further comprises a flexible keypad 23 of communication device 4 and carried by the glove member 5 at a location on an outside 15 of the hand 6 of the person when the glove member 5 is worn on the hand 6 of the person to permit the person to input information. This location advantageously permits the inside 14 of the person's hand 6 to be unobstructed to permit the person to use the hand 6 and to permit the user to actuate individual keys 27 of a flexible keypad 23 while the person's hand 6 is in use. The flexible keypad 23 is constructed using conventional keypad technology. The flexible keypad 23 generally includes individual keys 27 which are electrically coupled to each other with the flexible membrane 28 with integrated circuitry to allow the flexible keypad 23 to fit tightly on an outside 15 of hand 6.

Some of integrated circuits can be located underneath of each key 27 of flexible keypad 23 and electrically connected to each other with the flexible circuitry integrated into the flexible membrane 28. The glove member 5 further comprises a display 25 which is electrically coupled to flexible keypad 23 and carried by the glove member 5 at a location on an outside 15 of the wrist 18 of the hand 6 of the person when the glove member 5 is worn on the hand 6 of the person to provide the person with information and the time. This location advantageously permits the inside 14 of the person's hand 6 to be unobstructed to permit the person to use the hand 6 and to permit the user to view the display while the person's hand 6 is being used. The display 25 is constructed using conventional display technology and some integrated circuits can be located underneath of display 25 and electrically connected to integrated circuits located underneath of each key 27 of flexible keypad 23.

The display 25 is thin and may be rigid or flexible to conform to movements of the person's hand 6.

The display 25 can be positioned parallel or perpendicular to a longitudinal axis 20 of the wrist 18 of the person and the flexible keypad 23 can also be positioned parallel or perpendicular to a longitudinal axis 20. The preferable orientation of the flexible keypad 23 and the display 25 is perpendicular to a longitudinal axis 20 considering the angle of the person's view.

The flexible keypad 23 or display 25 or any part of glove member 5 can comprise an integrated compact antenna for receiving and sending signals.

The glove member 5 further comprises a battery 24 carried by the glove member 5 and mechanically secure the battery 24 to the glove member 5. Preferably, the battery 24 can be positioned along a longitudinal axis 20 of the wrist 18 on an inside 14 of the hand 6 of the person when the glove member 5 is worn on the hand 6 of the person. Battery 24 is electrically coupled to the communication device 4 with a flex circuit.

Glove member 5 can be designed with the finger compartment 30 only for the middle finger were the earpiece transducer 8 is located or for all fingers 16, including the middle finger were the earpiece transducer 8 is located.

The inside 14 and outside 15 of glove member 5 with one finger compartment 30 for the middle finger or with finger compartment 30 for all fingers 16 can be connected to each other with the elastic material 26 to fit any size of hand 6.

Glove member 5 can be designed using the traditional materials for gloves or it can be net glove 19 that is made of elastic net which will be convenient to wear during the hot summer time or in the hot environment.

Sequence Listing:

Not Applicable

What is claimed is:

1. A communication glove comprising:
a glove member adapted to be worn on a hand of a person; and
a communication device, carried by the glove member and adapted to be coupled to a battery and the transducers, having:
an earpiece transducer adapted to be coupled to the communication device and carried by the glove member at the most convenient place on a hand—at the top of middle finger at a location on the inside of the hand when the glove member is worn on the hand;
a microphone transducer adapted to be coupled to the communication device and carried by the glove member at a location on the inside of the wrist when the glove member is worn on the hand; and
a battery that is electrically coupled to the communication device and carried by the glove member at a location on the inside of the wrist when the glove member is worn on the hand.

2. The communication glove according to claim 1 further comprises the communication device comprising:
the flexible keypad adapted to be coupled to the display and carried by the glove member at a location on the outside of the hand when the glove member is worn on the hand of a person; and
the display adapted to be coupled to the flexible keypad and carried by the glove member at a location on the outside of the wrist where traditionally watch is located, when the glove member is worn on the hand of a person.

3. The flexible keypad according to claim 2 wherein rows of keys carried by the flexible membrane which is attached to the outside of the glove member and can be positioned in parallel or perpendicular to a longitudinal axis of the hand of the person.

4. The display according to claim 2 can be positioned in parallel or perpendicular to a longitudinal axis of the wrist of the person's hand.

5. The communication device according to claim 2 and 3 further comprising:
some of integrated circuits located underneath of each key of flexible keypad and electrically connected to each other with the flexible circuitry integrated into the flexible membrane; and
some integrated circuits located underneath of display and electrically connected to integrated circuits located underneath of each key of flexible keypad.

6. The glove member can be made of:
traditional materials for gloves and the inside of the glove member connected to the outside of the glove member with the elastic material to fit any size of person's hand; or
made of elastic net to fit comfortably any size of person's hand to wear it in the hot environment.

7. The communication glove comprising:
a glove member adapted to be worn on a hand of a person with the inside glove member comprising:
a earpiece transducer adapted to be coupled to a communication device and carried by the glove member at the top of a middle finger at a location on the inside of the glove member when the glove member is worn on the hand of the person to permit an ear of the person to listen to acoustic signals generated by the earpiece transducer when the hand of the person is held against a head of the person with the top of the finger against the person's ear;
a microphone transducer adapted to be coupled to a communication device and carried by the glove member at a location on the inside of the glove member on the wrist of the person's hand when the glove member is worn on the hand of the person to permit a mouth of the person to speak acoustic signals into the microphone transducer when the hand of the person is held against the head of the person, the microphone transducer and the earpiece transducer are located along and close to a common axis;

8. A communication glove according to claim 7 wherein the communication device further comprises:
a flexible keypad adapted to be coupled to the display and carried by the glove member at a location on the outside of the hand of the person when the glove member is worn on the hand of the person to permit the person to input information; and
a display adapted to be coupled to the flexible keypad and carried by the glove member at a location on the outside of the wrist of the person's hand where traditionally watch is located, when the glove member is worn on the hand of the person to provide the person with information.
